(19) United States
(12) Patent Application Publication
(10) Pub. No.: US 2004/0232660 A1
(43) Pub. Date: Nov. 25, 2004

(54) Pushcart with telescopic handle

(75) Inventor: Kung Cheng Chen, Taichung Hsien (TW)

Correspondence Address: TROXELL LAW OFFICE PLLC, SUITE 1404, 5205 LEESBURG PIKE, FALLS CHURCH, VA, 22041, US

(73) Assignee: E-MAKE CO., LTD.

(21) Appl. No.: 10/722,496

(22) Filed: Nov. 28, 2003

(30) Foreign Application Priority Data
May 23, 2003 (TW) 092209553

(51) Int. Cl. B62B 1/00

(52) U.S. Cl. 280/651

(57) ABSTRACT

A pushcart with telescopic handle, including a base seat and a dragging apparatus. Several wheels and the dragging apparatus are mounted on one face of the base seat. The dragging apparatus includes a first slide rail and a second slide rail. A first stopper section is disposed at one end of the first slide rail. The second slide rail is fitted in the first slide rail and reciprocally slidable out of or into the first slide rail. A second stopper section is disposed at one end of the second slide rail. The first stopper section serves to stop the second stopper section, whereby when extending, the second slide rail will not detach from the first slide rail. A handle section is disposed at the other end of the second slide rail for pushing/dragging the first slide rail to drive the base seat. The second slide rail further has a pivot section. After the second slide rail is extended out of the first slide rail, the pivot section is positioned on outer side of the first slide rail, whereby the second slide rail can be swung relative to the first slide rail.

### BACKGROUND OF THE INVENTION

The present invention is related to a pushcart with telescopic handle, and more particularly to a pushcart with telescopic handle which can be swung.

In order to facilitate the movement of a trunk (or a pushcart), generally the trunk is equipped with two wheels on one side and a telescopic handle. When not used, the handle is retracted. In use, the handle is extended for dragging the trunk.

The handle is a substantially U-shaped bar. Another hollow U-shaped bar is fixed on the trunk. The handle is reciprocally movably fitted in the hollow U-shaped bar. A stopper member is disposed between the two U-shaped bars, whereby when pulled relative to each other, the two U-shaped bars will not detach from each other. After extended, the two U-shaped bars are fixedly connected. When dragging the trunk, a user's hand lifts one end of the trunk and the other end of the trunk with the two wheels contacts with the ground. Under such circumstance, the hollow U-shaped bar of the trunk and the ground contain an angle. Therefore, the user's hand still needs to bear the weight of the trunk.

Alternatively, the trunk or pushcart can be equipped with at least three wheels on one face for horizontally contacting with the ground. In this case, when dragging the trunk, the hollow U-shaped bar of the trunk or the pushcart is parallel to the ground. A user can stand and conveniently drag the trunk. Under such circumstance, it is necessary to pivotally connect one end of the hollow U-shaped bar with one end of the handle. Accordingly, when dragging the trunk, the ground will totally bear the weight of the trunk or the article placed on the pushcart. However, it is impossible to retract the handle.

### SUMMARY OF THE INVENTION

It is therefore a primary object of the present invention to provide a pushcart with telescopic handle. When dragged, the handle can be swung so that a user needn't bear the weight of the pushcart or the article placed thereon. When not used, the handle can be retracted to reduce the storage room.

It is a further object of the present invention to provide the above pushcart which meets the requirement of human body engineering. Therefore, different users with different heights and configurations can all conveniently use the pushcart.

According to the above objects, the pushcart of the present invention includes a base seat and a dragging apparatus. Several wheels and the dragging apparatus are mounted on one face of the base seat. The dragging apparatus includes a first slide rail and a second slide rail. A first stopper section is disposed at one end of the first slide rail. The second slide rail is fitted in the first slide rail and reciprocally slidable out of or into the first slide rail. A second stopper section is disposed at one end of the second slide rail. The first stopper section serves to stop the second stopper section, whereby when extending, the second slide rail will not detach from the first slide rail. A handle section is disposed at the other end of the second slide rail. The second slide rail further has a pivot section. After the second slide rail is extended out of the first slide rail, the pivot section is positioned on outer side of the first slide rail, whereby the second slide rail can be swung relative to the first slide rail.

The present invention can be best understood through the following description and accompanying drawings wherein:

### BRIEF DESCRIPTION OF THE DRAWINGS

FIG. 1 is a perspective view of a first embodiment of the present invention in a using state;

FIG. 2 is a perspective view according to FIG. 1, in which the second slide rail of the dragging apparatus is retracted;

FIG. 3 is a perspective exploded view of the dragging apparatus of the first embodiment of the present invention;

FIG. 4 is a front view of the dragging apparatus of the first embodiment of the present invention;

FIG. 5 is a front view of the first embodiment of the present invention, in which the second slide rail of the dragging apparatus is retracted;

FIG. 6 is a perspective view of the dragging apparatus of a second embodiment of the present invention; and

FIG. 7 is a perspective exploded view of a part of the dragging apparatus of the second embodiment of the present invention.

### DETAILED DESCRIPTION OF THE PREFERRED EMBODIMENTS

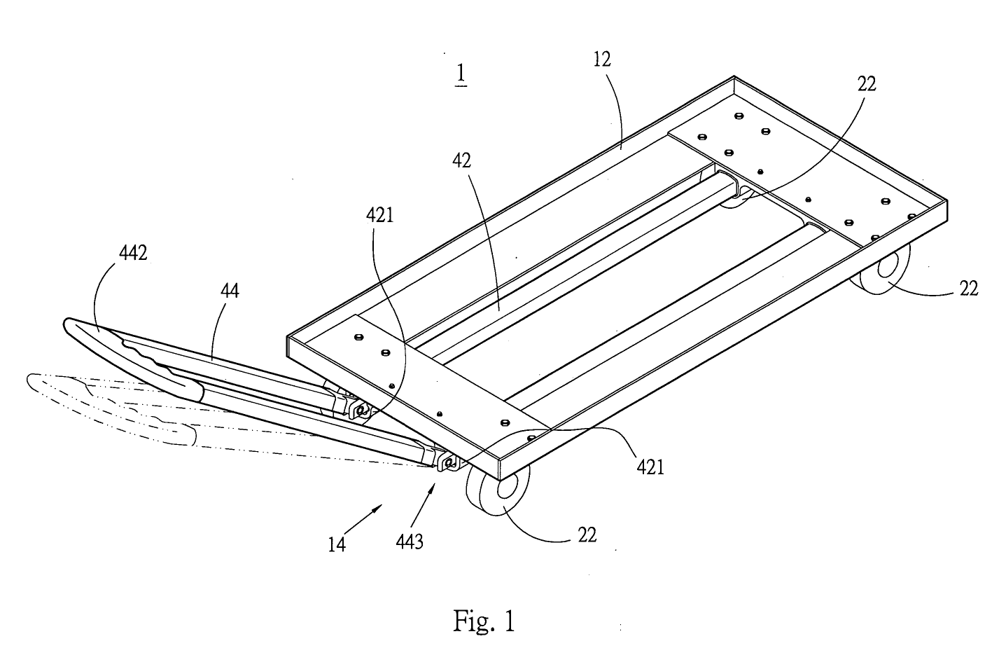

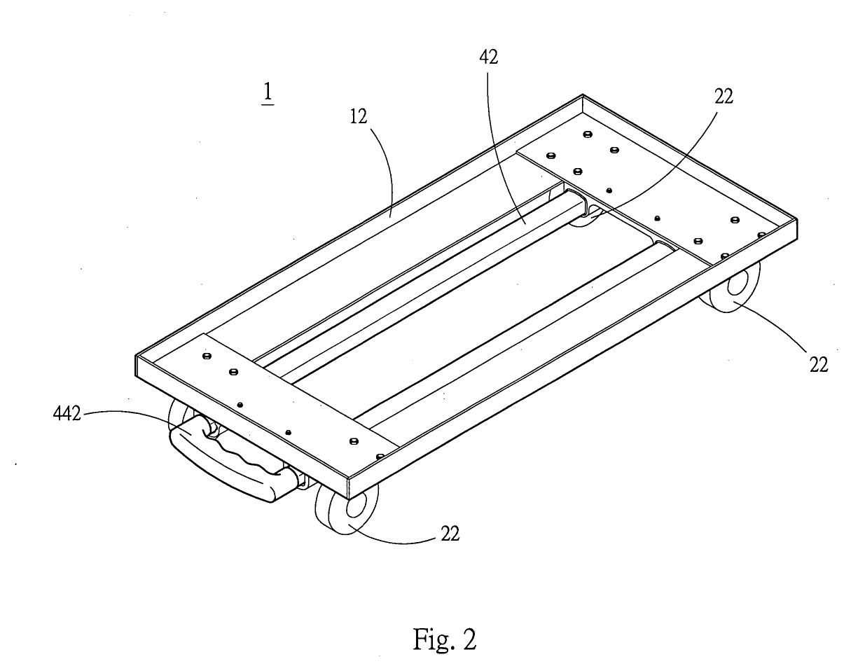

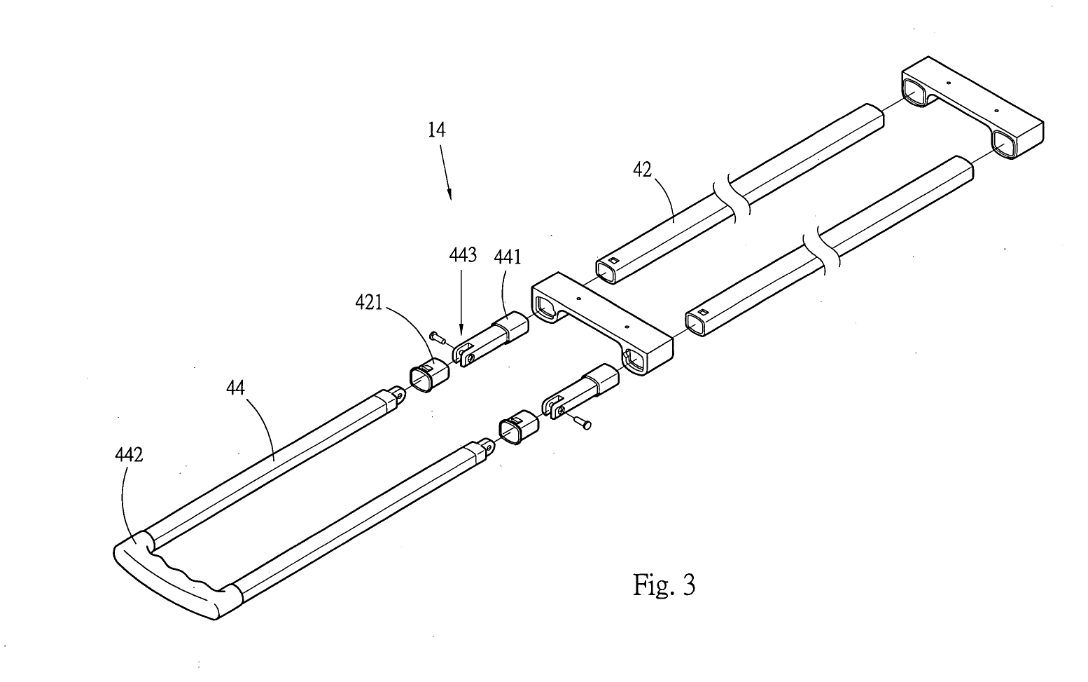

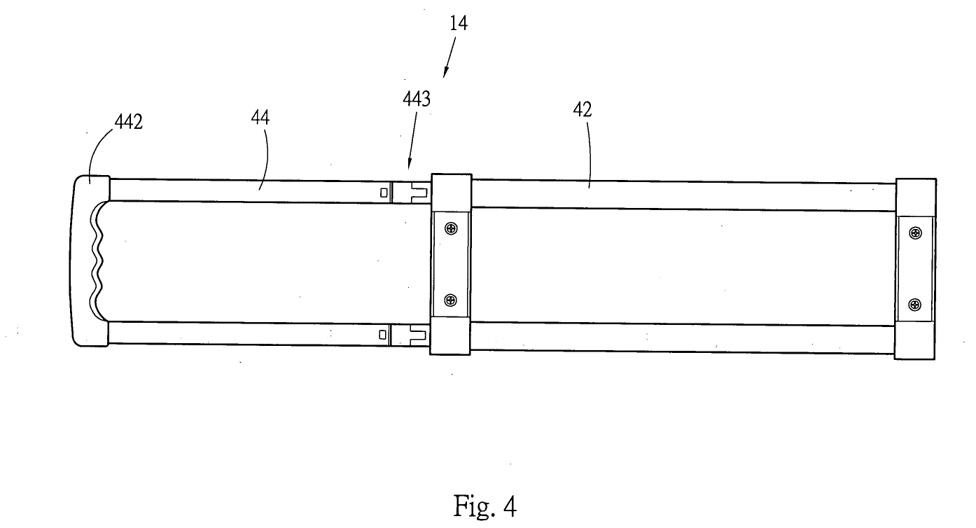

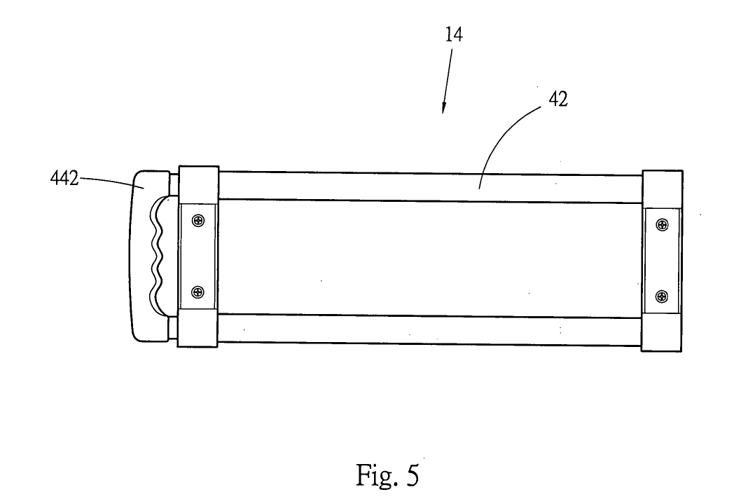

Please refer to FIGS. 1 to 5. The pushcart 1 with telescopic handle of the present invention includes a base seat 12 and a dragging apparatus 14.

The dragging apparatus 14 and several wheels 22 are mounted on one face of the base seat 12.

The dragging apparatus 14 includes a first slide rail 42 and a second slide rail 44. The first slide rail 42 is fixed on the base seat 12. A first stopper section 421 is disposed at one end of the first slide rail 42.

The second slide rail 44 is fitted in the first slide rail 42 and can be reciprocally slid out of or into the first slide rail 42. A second stopper section 441 is disposed at one end of the second slide rail 44. The first stopper section 421 serves to stop the second stopper section 441, whereby when extending the second slide rail 44, the second slide rail 44 will not detach from the first slide rail 42. A handle section 442 is disposed at the other end of the second slide rail 44 for pushing/dragging the first slide rail 42 to drive the base seat 12.

The second slide rail 44 further includes a pivot section 443 disposed thereon. Accordingly, the pivot section 443 is reciprocally slidable out of or into the first slide rail 42 along with the second slide rail 44. After the second slide rail 44 is extended out of the first slide rail 42, the pivot section 443 is positioned on outer side of the first slide rail 42, whereby the second slide rail 44 can be swung relative to the first slide rail 42.

According to the above arrangement, the pushcart 1 of the present invention has the following advantages:

1. The pivot section 443 is reciprocally slidable out of or into the first slide rail 42. Accordingly, the pivot section 443 can be retracted and hidden in the first slide rail 42. This is different from the conventional structure in which the pivot device cannot be retracted and hidden.

2. When dragged, the second slide rail 44 can be swung relative to the first slide rail 42. Therefore, the wheels 22 can fully contact with the ground and a user needn't bear the weight of the pushcart 1 or the article placed thereon.

3. When not used, the second slide rail 44 can be retracted and hidden to reduce the storage room.

4. When dragged, the second slide rail 44 can be swung relative to the first slide rail 42. This meets the requirement of human body engineering. Therefore, different users with different heights and configurations can all conveniently use the pushcart.

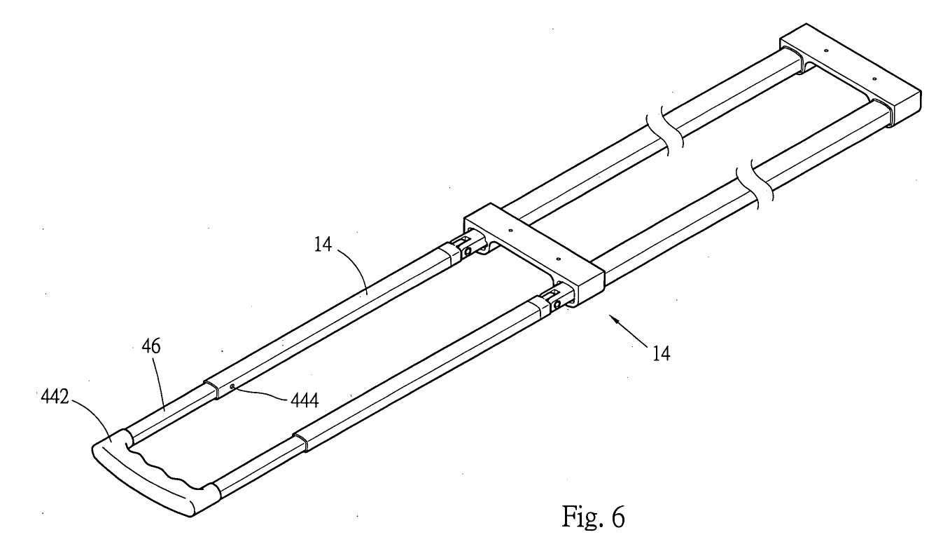

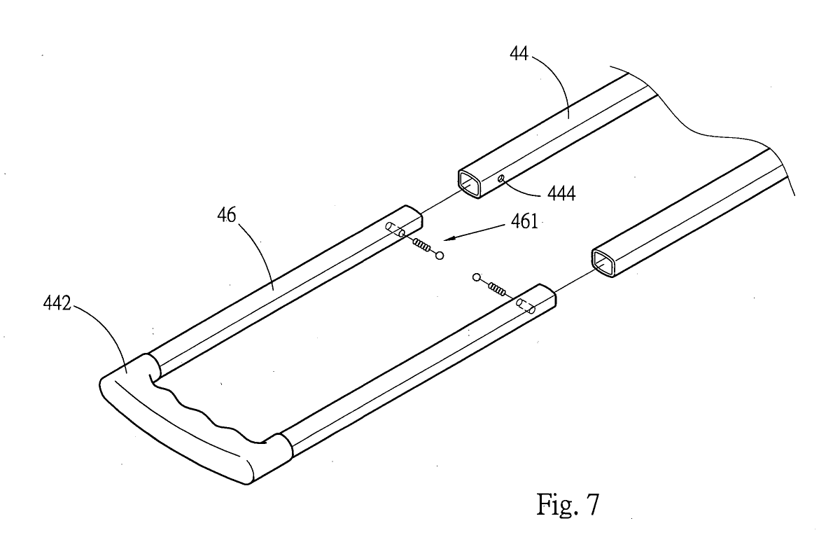

FIGS. 6 and 7 show a second embodiment of the present invention, in which the handle section 442 has a third slide rail 46 extending therefrom. The third slide rail 46 is fitted in the second slide rail 44 and reciprocally slidable out of or into the second slide rail 44. This embodiment is adaptable to those users with higher and bigger configurations. The other end of the second slide rail 44 is equipped with a third stopper section 444 and a fourth stopper section 461 is disposed at one end of the third slide rail 46 for stopping the third stopper section 444. Therefore, when extending the third slide rail 46, the third slide rail 46 will not detach from the second slide rail 44.

In the first embodiment, the first slide rail 42 is a pair of hollow bar bodies and the second slide rail 44 is a pair of bar bodies. The shape of the outer periphery of the second slide rail 44 corresponds to the shape of the inner periphery of the first slide rail 42.

In the second embodiment, the first slide rail 42 is a pair of hollow bar bodies and the second slide rail 44 is also a pair of hollow bar bodies. The shape of the outer periphery of the second slide rail 44 corresponds to the shape of the inner periphery of the first slide rail 42. The third slide rail 46 is a pair of bar bodies. The shape of the outer periphery of the third slide rail 46 corresponds to the shape of the inner periphery of the second slide rail 44.

The above embodiments are only used to illustrate the present invention, not intended to limit the scope thereof. Many modifications of the above embodiments can be made without departing from the spirit of the present invention.

What is claimed is:

1. A pushcart with telescopic handle, comprising:
a base seat, several wheels being mounted on one face of the base seat; and
a dragging apparatus disposed on the face of the base seat, the dragging apparatus including a first slide rail and a second slide rail, the first slide rail being fixed on the base seat, a first stopper section being disposed at one end of the first slide rail, the second slide rail being fitted in the first slide rail and reciprocally slidable out of or into the first slide rail, a second stopper section being disposed at one end of the second slide rail, the first stopper section serving to stop the second stopper section, whereby when extending the second slide rail, the second slide rail will not detach from the first slide rail, a handle section being disposed at the other end of the second slide rail for pushing/dragging the first slide rail to drive the base seat, said pushcart being characterized in that the pushcart further comprising a pivot section disposed on the second slide rail, whereby the pivot section is reciprocally slidable out of or into the first slide rail along with the second slide rail, after the second slide rail is extended out of the first slide rail, the pivot section being positioned on outer side of the first slide rail, whereby the second slide rail can be swung relative to the first slide rail.

2. The pushcart with telescopic handle as claimed in claim 1, wherein the handle section has a third slide rail extending therefrom, the third slide rail being fitted in the second slide rail and reciprocally slidable out of or into the second slide rail, the other end of the second slide rail being equipped with a third stopper section and a fourth stopper section being disposed at one end of the third slide rail for stopping the third stopper section, whereby when extending the third slide rail, the third slide rail will not detach from the second slide rail.

3. The pushcart with telescopic handle as claimed in claim 1, wherein the first slide rail is a pair of hollow bar bodies and the second slide rail is a pair of bar bodies, the shape of outer periphery of the second slide rail corresponding to the shape of inner periphery of the first slide rail.

4. The pushcart with telescopic handle as claimed in claim 2, wherein the first slide rail is a pair of hollow bar bodies and the second slide rail is also a pair of hollow bar bodies, the shape of outer periphery of the second slide rail corresponding to the shape of inner periphery of the first slide rail, the third slide rail being a pair of bar bodies, the shape of the outer periphery of the third slide rail corresponding to the shape of inner periphery of the second slide rail.
